(19) United States
(12) Patent Application Publication
(10) Pub. No.: US 2002/0124809 A1
(43) Pub. Date: Sep. 12, 2002

(54) Method of luring an animal to a predetermined place

(75) Inventors: Carlo Verburg, Pijnacker (NL); Alexander van der Lely, Rotterdam (NL); Renatus Ignatius Josephus Fransen, Vlaardingen (NL); Karel van den Berg, Bleskensgraaf (NL)

Correspondence Address: MASON, MASON & ALBRIGHT, 2306 South Eads Street, P.O. Box 2246, Arlington, VA, 22202, US

(73) Assignee: LELY RESEARCH HOLDING A.G., Swiss limited liability company

(21) Appl. No.: 09/832,117

(22) Filed: Apr. 11, 2001

Related U.S. Application Data
(63) Continuation of application No. PCT/NL00/00505, filed on Jul. 18, 2000.

(30) Foreign Application Priority Data
Aug. 11, 1999 (NL) 1012808

(51) Int. Cl. A01K 1/00

(52) U.S. Cl. 119/516

(57) ABSTRACT

A method and apparatus for attracting an animal to a predetermined place such as a milking stall or feeding stall wherein the animal so attracted undergoes a predetermined process that relates to the animal being milking or fed, or both. In order to attract the animal into the stall a previously defining climatic parameter is established artificially which will attract the animal to proceed voluntarily to the stall or another predetermined place where it undergoes a process such as being milked or fed or both. The artificial climate disclosed comprises wetting the animal with a water vapor and causing an air flow over the wetted area of the animal. During the process, the animal is monitored for signs of thermal stress and the wetting and cooling processes are discontinued before the end of the milking or feeding or both so that the animal will voluntarily depart from the stall or predetermined place after it has been milked or fed or both.

### RELATED APPLICATION

This Application is a continuation of International Application No. PCT/NL00/00505, filed Jul. 18, 2000.

### FIELD OF THE INVENTION

The invention relates to a method of luring an animal to a predetermined place, such as a milking stall or a feeding stall, or a stall for both milking and feeding, where the animal lured undergoes a predetermined treatment, or where a predetermined animal-related action, such as milking or feeding or a combination thereof takes place.

### BACKGROUND OF THE INVENTION

In a known method, an animal is lured to a milking stall by means of concentrate.

In practice, however, it has been found that, under certain climatic conditions, such as in very warm weather, the animal will not go to the milking stall, in spite of the fact that it is supplied with concentrate for the animal's consumption.

The invention aims at a method in which the above-mentioned problem is obviated or at least minimized.

### SUMMARY OF THE INVENTION

In accordance with the invention, this is achieved in that, at least during a predetermined stage of the treatment or the action, or both, at least one previously defined climate parameter is provided artificially at a relevant location. It has been found that by regulating the climate at the relevant place of treatment, animals will go to such place more frequently.

According to an inventive feature, the degree of humidity is regulated and, more in particular, increased. According to an aspect of the invention, increasing the degree of humidity can be realized by applying liquid between the hairs or on the skin or at both places. This can be achieved, more particularly, by atomizing the liquid to a fine spray and subsequently dispersing same. According to an invention feature, it is also possible to apply the liquid directly between the hairs or on the skin of the animal, or at both locations, by rubbing or brushing, or both. Especially during warm weather this has proved to be a pleasant experience for the animals. In order to avoid the use of too much liquid for wetting the animal, according to an inventive feature, a maximum amount of liquid to be used for wetting the animal is previously fixed. According to another inventive feature, during wetting the animal it is checked whether droplets are formed on the animal's skin or fall from the animal. According to a further inventive feature, wetting of the animal is stopped if formation of droplets is ascertained. Formation of droplets is not only disadvantageous to the liquid consumption, but may also result in certain parts, such as the teats, of the animal being undesirably wetted by the liquid. By evaporation of the liquid on the skin or between the hairs of the animal, the animal cools off. According to the invention, in particular the animal's back is cooled.

In accordance with another inventive feature, the air flow is regulated. More in particular the air flow is forcibly increased, such as by means of a ventilator. By causing forced air to flow over the wetted surface of the animal, an even quicker cooling of the animal is achieved. Therefore, the invention also relates to a method in which first the degree of humidity is increased, as described in the foregoing, and then the air flow is regulated, which is also described in the foregoing.

For the purpose of being able to check the cooling process or to control it, or to do both, according to an inventive feature, during or after regulation of the climate parameter, or during both periods, at least the temperature, in particular the temperature of the skin or the body temperature or the ambient temperature in the vicinity of the animal or any combination thereof, is determined. According to a further inventive feature, cooling of the animal is stopped when a previously determined temperature is reached. For the purpose of being able to follow cooling even more accurately, according to an inventive feature, the animal's behavior is observed during cooling, and cooling is stopped if the animal's behavior changes. According to a further inventive feature, the animal's behavior can be deduced from deviations from the number of movements of the animal per unit of time.

According to again another inventive feature, regulation of the climate parameters is performed during a previously fixed duration. According to a further inventive feature, that duration is adjustable. The duration of the treatment can also be calculated on the basis of historical data about previous actions related to the relevant animal. According to an aspect of the invention, this calculation can be made on the basis of the duration of milkings or pre-treatments or post-treatments, or any combination thereof, of the relevant animal. According to again another inventive feature, regulation of one of the climate parameters is stopped when approximately three quarters of the action or the treatment, or both, has been performed. The latter measure is of importance to ensure that the animal leaves the stall after the action or the treatment, or both, has ended. If regulation of the climate parameters continues throughout the action or the treatment, or both, the result is that the animal will not leave the place well after the action or the treatment, or both, has ended. This may be very disadvantageous when, for example, the milking is carried out by means of a milking robot because it results in reducing the effective capacity of the milking robot.

In accordance with a further inventive feature, during regulation of one of the climate parameters certain parts of the animal are shielded. More in particular the animal's head and the udder or the teats or a combination of these parts are shielded.

The invention also relates to an apparatus for applying the method described above, which apparatus is provided at a place where an animal-related action is performed, and wherein, at least during a stage of the action, at least one climate parameter is regulated artificially. According to a further aspect of the invention, the regulating means comprises wetting means with the aid of which a liquid reduced to a fine spray is applied to a part of the animal, in particular between the hairs of that part of the animal, whereupon an air flow is directed over the wetted part with the aid of air displacing means. According to again another aspect of the invention, the apparatus is arranged in a milking stall or a foremilking stall or in a cleaning compartment for cleaning certain parts, such as the teats, of an animal, or in a post-treatment compartment, or in a combination of such places. According to a further inventive feature, a milking robot is arranged in the milking stall, by means of which milking robot teat cups can automatically be connected to the teats of an animal to be milked.

### BRIEF DESCRIPTION OF THE DRAWINGS

The invention will now be explained in further detail with reference to the accompanying drawings, in which:

FIG. 1 is a side elevational view of a first embodiment of the invention; and

FIG. 2 is a similar view of a second embodiment of an apparatus according to the invention.

### DETAILED DESCRIPTION OF THE PREFERRED EMBODIMENT

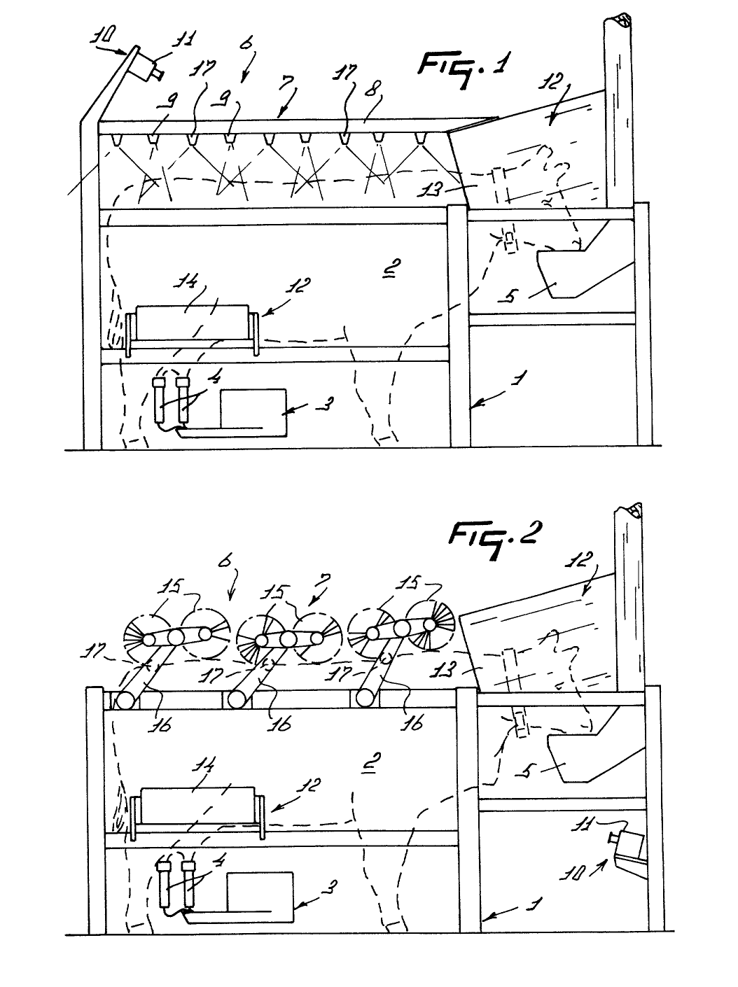

FIG. 1 is a side view of a milking compartment 1 with a cow 2 present therein. Milking compartment 1 comprises a milking robot 3 with teat cups 4 which are connected automatically to the teats of cow 2 by means of milking robot 3. Near the front side of milking compartment 1 is further disposed a feeding trough 5 to which concentrate can be supplied in metered portions. Milk compartment 1 is further provided with regulating means 6 with the aid of which at least one previously defined climate parameter is artificially established in milking compartment 1. Regulating means 6 comprises a wetting means 7 with the aid of which at least the back of cow 2 is wetted. Wetting means 7 comprise a sprayer beam 8 with nozzles 9, by means of which a liquid is atomized to a fine spray. After the liquid reduced to a fine spray has been applied to the back of cow 2, air is directed over the wetted surface by means of the sprayer beam 8 and nozzles 9. In this manner the back of cow 2 is cooled. During wetting, cow 2 is checked with the aid of detection means 10 whether or not droplets are formed. To that end detection means 10 comprises a camera 11. In order to prevent certain parts of cow 2 from coming into contact with the liquid, milking compartment 1 is further provided with shielding means 12. In the present embodiment shielding means 12 comprise a transparent shielding cap 13 which covers the head of cow 2 during wetting. Shielding means 12 further comprise a second shielding cap 14 by mans of which the udder of cow 2 can be shielded. The second shielding cap 14 is pivotably fitted to milking compartment 1.

FIG. 2 shows a second embodiment of the invention, in which parts corresponding to those of the first embodiment are indicated by the same reference numerals. In the second embodiment of the invention, wetting means 7 comprises motor-drivable brushes 15 which are provided with liquid supply means with the aid of which liquid can be supplied to the brushes during brushing. Thus, the liquid is rubbed in the hair of cow 2 by means of brushes 15. These motor-drivable brushes 15 are each disposed on a pivotable arm 16 which is connected to milking compartment 1. Pivotable arm 16 is further provided with air displacing means 17 for directing air onto the wetted surface of cow 2 after or during brushing.

Although we have disclosed the preferred embodiments of our invention, it is to be understood that it is capable of other adaptations and modifications within the scope of the following claims:

28. A method of attracting an animal to a stall to undergo a predetermined animal related process at said stall, the method comprising producing at said stall an artificial climatic condition which is pleasurable to said animal.

29. A method in accordance with claim 28 wherein the climatic condition artificially produced at said stall comprises regulating the degree of water vapor.

30. A method in accordance with claim 29 wherein said degree of water vapor is increased.

31. A method in accordance with claim 30 wherein the degree of said water vapor is increased by applying water onto the skin of the animal in said stall.

32. A method in accordance with claim 30 wherein said comprises regulating air flow at said stall.

41. A method in accordance with claim 40 wherein said air flow is regulated by a ventilator.

42. A method in accordance with claim 28 wherein the steps of producing an artificial climatic condition at said stall comprises first increasing the water vapor at said stall by the application of water to the animal and second providing an air flow which is directed on the animal in said stall.

43. A method in accordance with claim 28 comprising the further steps of determining the temperature of the animal and the ambient temperature of the atmosphere in the vicinity of the animal.

44. A method in accordance with claim 43 comprising cooling the animal at said stall until said temperature of said animal reaches a predetermined temperature.

45. A method in accordance with claim 28 comprising cooling the animal in said stall and observing the animal's behavior while being so cooled and discontinuing the cooling of the animal when the animal's behavior changes.

46. A method in accordance with claim 45 wherein the animal's behavior is considered to be changed when deviations from a number of movements of the animal occur per unit time.

47. A method in accordance with claim 28 wherein the step of producing an artificial climatic condition at said stall is discontinued upon the expiration of a predetermined duration of time after the animal has entered said stall.

48. A method in accordance with claim 47 wherein said predetermined duration of time is adjustable.

49. A method in accordance with claim 48 comprising adjusting said predetermined duration of time on the basis of historical data relating to the animal in said stall.

50. A method in accordance with claim 47 wherein said historical data comprises information as to the duration of time required for milking the animal which was gathered during previous milkings of the animal.

51. A method in accordance with claim 28 which comprises determining the anticipated duration of time that the animal will remain in said stall and discontinuing the production of an artificially climatic condition which is pleasurable to the animal when approximately three-quarters of said duration of time has elapsed.

52. A method in accordance with claim 28 comprising the further step of shielding selected parts of the animal while the method progresses.

53. An apparatus comprising a stall for receiving an animal and means for creating an artificial climatic condition in said stall which is attractive to the animal and which induces the animal voluntarily to enter said stall.

54. An apparatus in accordance with claim 53 wherein said means for producing a climatic condition which is pleasurable to said animal in said stall comprises wetting means that reduces a liquid to a fine spray that is applied at least to a part of the animal and an air displacing means which directs an air flow over said wetted part.

55. An apparatus in accordance with claim 53 comprising a milking robot in said stall for automated milking the animal in said stall by said milking robot.

56. An apparatus in accordance with claim 53 comprising foremilking means at said stall for foremilking the animal in said stall.

57. An apparatus in accordance with claim 53 comprising cleaning means in said stall for cleaning parts of the animal.

58. An apparatus in accordance with claim 53 comprising a milking robot arranged in said stall.
